(19) United States
(12) Patent Application Publication
(10) Pub. No.: US 2008/0136307 A1
(43) Pub. Date: Jun. 12, 2008

(54) Reversible lamp base

(76) Inventors: Ceferino Garcia, Juarez (MX); Richard C. Laird, El Paso, TX (US)

Correspondence Address: OSRAM SYLVANIA Inc., 100 Endicott Street, Danvers, MA, 01923, US

(21) Appl. No.: 11/583,445

(22) Filed: Oct. 19, 2006

(51) Int. Cl. H01J 5/00; H01J 5/50; H01J 5/48

(52) U.S. Cl. 313/317; 313/318.01; 313/49; 313/51

(57) ABSTRACT

A reversible base for a lamp can reduce the number of parts needed for differing lamp assemblies. The preferred base is an insulating body with a first receptacle for a lamp capsule including a cavity, and a second receptacle. The second receptacle is aligned in opposition to the first receptacle, being similar in size and shape. A support is positioned between an end of the first receptacle and an end of the second receptacle and extends radially from a mid-region between the first and second receptacles. The support includes a radially extending flange having a face and a sidewall. Electrical contacts are held on the support, and may be axially aligned pins extending from the face of the flange. The pins may be electrically extended for coupling in either the first or second receptacle to lamp leads.

### CROSS-REFERENCE TO RELATED APPLICATIONS

Not Applicable

### BACKGROUND OF THE INVENTION

A lamp is commonly mounted in a base designed for a specific socket. For each socket there then a unique base. This means separate parts must be designed, manufactured and stored. There is then a need to simplify the parts supply chain. A dual use base would lower the supply chain cost in the production of lamps.

### FIELD OF THE INVENTION

The invention relates to electric lamps. More particularly the invention is concerned with an electric lamp with a reversible base.

### DESCRIPTION OF THE RELATED ART INCLUDING INFORMATION DISCLOSED UNDER 37 CFR 1.97 AND 1.98

Lamp capsules with relatively hot supporting regions are commonly held in ceramic bases. The ceramic bases are often uniquely designed to mechanically couple between a particular lamp capsule and a particular socket, to properly connect and protect the electrical connections. As a result each lamp type is an individually designed base, and constructed with a unique base. This is expensive. At times it would be convenient to be able to mount a lamp in a socket from either the front side of the socket or from the rear side of the socket. An example would be to position a lamp in a reflector from either the open front or from the closed rear.

### BRIEF SUMMARY OF THE INVENTION

A reversible base for a lamp capsule can be made from an insulating body having a first receptacle for a lamp capsule, and a second receptacle for a lamp capsule, the second receptacle being axially aligned to face in opposition to the first receptacle. The insulating body includes a support extending radially from a mid-region between the first receptacle and the second receptacle. Electrical contacts are held on the support and electrically coupled to lamp contacts exposed for electrical contact in the first receptacle and exposed for electrical contact in the second receptacle.

### BRIEF DESCRIPTION OF THE SEVERAL VIEWS OF THE DRAWINGS

FIG. 1 shows a cross sectional view of a reversible lamp base.

FIG. 2 shows a schematic cross sectional view of a lamp capsule mounted in a reversible lamp base with the reversible base aligned with the electrical contacts in the up or internal position.

FIG. 3 shows a schematic cross sectional view of a lamp capsule mounted in a reversible lamp base with the reversible base aligned with the electrical contacts in the down or external position.

FIG. 4 shows a schematic cross sectional view of an alternative reversible lamp base.

### DETAILED DESCRIPTION OF THE INVENTION

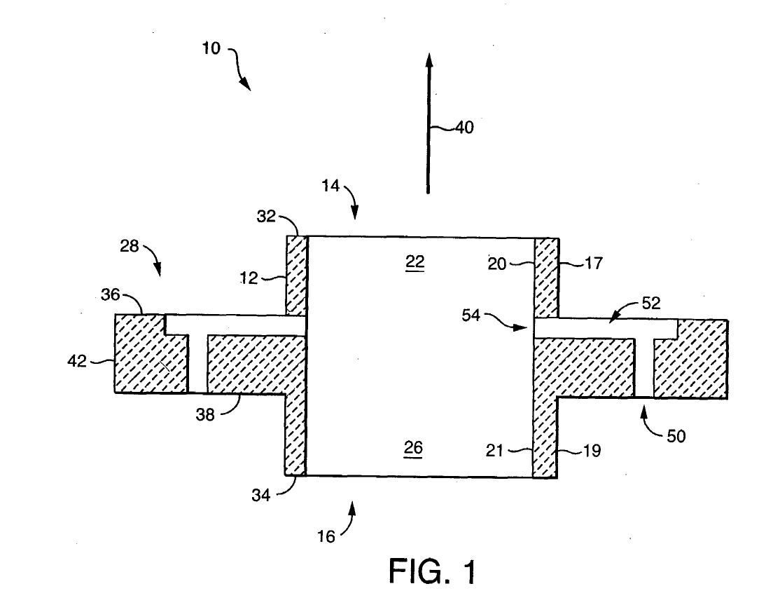

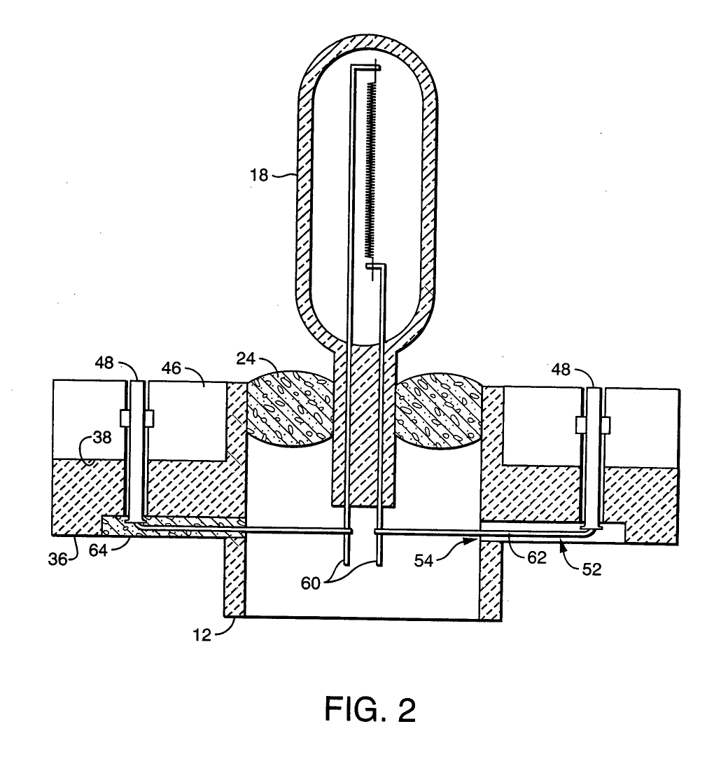

FIG. 1 shows a cross sectional view of a reversible lamp base 10. FIG. 2 shows a schematic cross sectional view of a lamp mounted in a reversible lamp base with the reversible base aligned with the electrical contacts in the up or internal position. The reversible base 10 for a lamp capsule 18 comprises an insulating body 12 having a first receptacle 14 for a lamp capsule 18 and a second receptacle 16 for a lamp capsule 18. The body 12 is preferably molded from an electrically insulating ceramic capable of sustaining high temperatures, but could be formed from a high temperature plastic or other appropriate material.

The first receptacle 14 is sized and shaped to received and support a lamp capsule 18. It is common for a lamp receptacle to be a cavity 22 formed, for example by molding, with substantially axially parallel sidewalls 20 and sized to receive the press sealed end of the lamp capsule 18 to be supported. An appropriate cement 24 may be used to fill the receptacle cavity 22 around the press sealed end of the lamp capsule 18 to hold the lamp capsule 18 in place in the first receptacle 14.

A second receptacle 16 for a lamp capsule 18 is similarly formed in the insulating body 12. The second receptacle 16 is axially (axis 40) aligned to face in opposition to the first receptacle 14. The cavity 22 of the first receptacle 14 may extend axially to join or form a second cavity 26 forming the second receptacle 16. In the preferred embodiment, the first receptacle 14 is similar in size and shape to the second receptacle 16 so the same lamp capsule 18 can be optionally installed in either the first receptacle 14 or in the second receptacle 16. The first receptacle 14 has an outer wall 17 configured for axial insertion in a corresponding socket. Similarly the second receptacle 16 has an outer wall 19 configured for axial insertion in a corresponding socket. In one embodiment the outer wall 17 was similar in size and shape to the outer wall 19.

The preferred body 12 includes a support 28 between an axial end 32 of the first receptacle 14 and an axial end 34 of the second receptacle 16. The support 28 extends radially away from the mid-region between the first receptacle 14 and the second receptacle 16. The preferred support 28 includes a radially extending flange 36 having a face 38 and a radial sidewall 42. In the preferred embodiment the flange face 38 is flat and transverse to the axis 40 thereby providing an alignment surface for an assembled lamp. The radial sidewall 42 may be shaped to fit a socket 46 with or without keying. The radial sidewall 42 may then be circular, oval, square or similarly radially shaped according to design choice. The radial flange 36 may be used in a coupling with a snap or clip coupling to mate the lamp base 10 to a socket 46.

In one embodiment, the flange 36 was formed with an included first through hole 50, and a narrow trench 52 extending from the through hole 50 along the surface of the flange 36. The trench 52 extended to a passage 54 formed through the receptacle wall 17 to the interior of the base 10. The flange 36 was similarly formed on an opposite side with a second through hole, a second trench and a second passage.

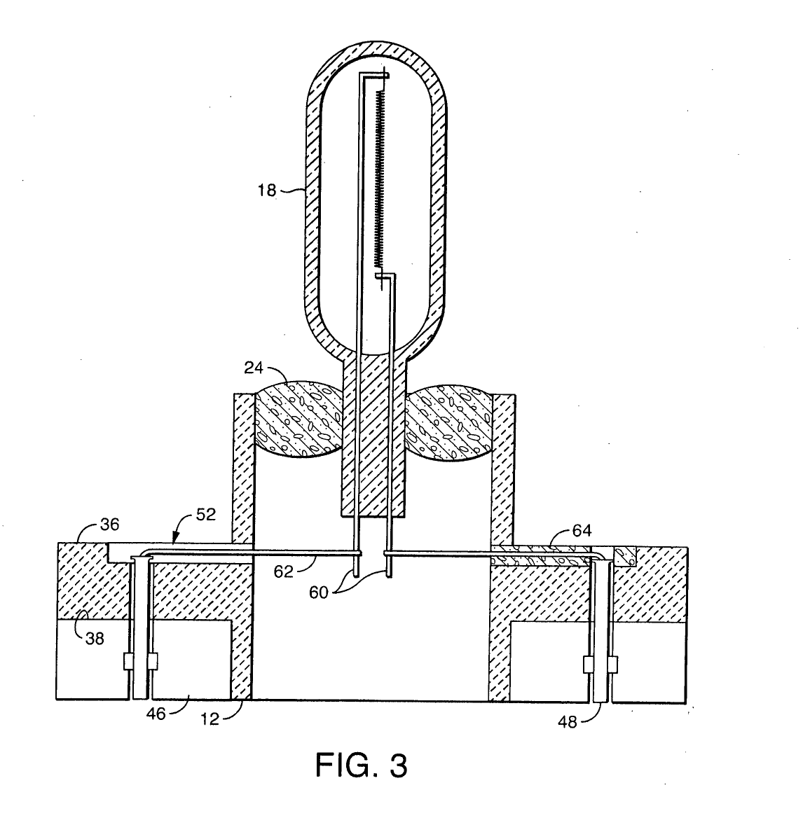

FIG. 2 shows a schematic cross sectional view of a lamp capsule mounted in a reversible lamp base 12 with the reversible base aligned with the electrical contacts in the up or internal position. Electrical contacts 48 are held on the flange 36. The preferred electrical contacts 48 are axially aligned pins extending from the face 38 of the flange 36. A pin may be attached by inserting a metal tubular body in the through hole 50 and rolling or swaging the end of the tube against the ceramic body to the rivet pin in place. Preferably the electrical contacts 48 are positioned diametrically to be on opposite sides of the axis 40. The electrical contacts 48 are electrically coupled through the body 12 to lamp leads 60 exposed in the first receptacle or exposed in the second receptacle as the case may be. In one embodiment, the electrical contact 48 may be electrically coupled to a wire 62 positioned in the trench 52, and threaded through the passage 54 to be available for connection to a lamp lead 60 in the receptacle interior. The second electrical contact may be similarly connected to a second lamp lead. Once the wire 62 is connected to the electrical contact 48 and positioned in the trench 52, the trench 52 may be filled with a ceramic cement 64 to safely enclose the wire 62. Other electrical connections between the lamp contacts (pins) to lamp capsule leads may be designed, such as using a molded in place connector. FIG. 3 shows a schematic cross sectional view of a lamp capsule mounted in a reversible lamp base with the reversible base aligned with the electrical contacts 48 in the down or external position.

A lamp is constructed by molding the insulating body 12, and installing in the electrical contacts 48, wire 62, and cement 64. The lamp base 10 is then axially oriented in the desired direction with electrical contacts 48 pointing either towards the lamp capsule 18 or pointing away from the lamp capsule 18 as is desired. The lamp capsule 18 is then axially inserted in the insulating body 12 cemented in place. The lamp leads 60 are connected to the wires 62. In the preferred embodiment, the flange face 38 is used as the lamp positioning surface, so in assembly the lamp capsule 18 is axially positioned relative to the flange face 38 to establish proper optical positioning of the lamp capsule 18 in an optical system. Once the capsule 18 is aligned relative to the body 12, the lamp leads 60 are then welded, soldered or crimped to the wires 62. The receptacle cavity (22, 26) is then filled with a cement 24 filling the region between the inside receptacle sidewalls and the nearby capsule 18. The second (remaining) receptacle cavity may also be filled, for example with potting. The single body 12 can then be attached to the lamp capsule 18 either pins up or pins down. In this way one insulating body 12 can be used to construct the two differing lamp assemblies, either internally or externally electrically coupled lamps.

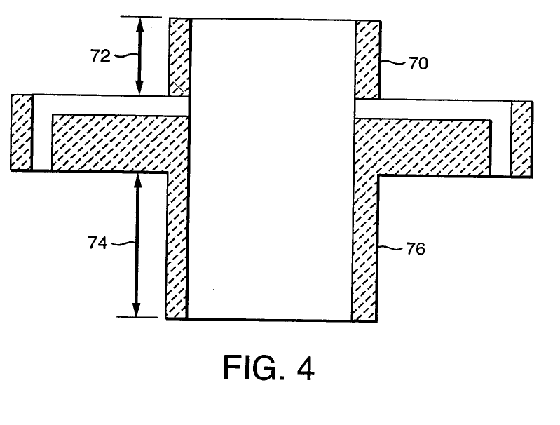

FIG. 4 shows a schematic cross sectional view of an alternative reversible lamp base. In an alternative embodiment the insulating body was formed with a first receptacle 70 that was relatively shorter 72 axially than a relatively longer 74 second receptacle 76. The axially difference in length between the short side and the long side may be set so the light source (filament, arc etc.) is positioned axially at the same point whether a pins down lamp (short side receptacle) is used on the top side of the socket or a pins up lamp (long side receptacle) is threaded through from bottom side of the socket. A lamp capsule installed in the short side receptacle using electrical contacts down, could then be coupled to the top side of the socket, and could be replaced by a lamp capsule installed in the long side receptacle using electrical contacts up, and inserted through the socket and coupled the from bottom side of the socket. In this way, the same lamp capsules, bases and socket components can be used for front or rear mounted lamp assembles that position the lamp capsule in the same final optical position.

While there have been shown and described what are at present considered to be the preferred embodiments of the invention, it will be apparent to those skilled in the art that various changes and modifications can be made herein without departing from the scope of the invention defined by the appended claims.

What is claimed is:

1. A reversible base for a lamp capsule comprising:
an insulating body having
a first receptacle for a lamp capsule,
a second receptacle for a lamp capsule, the second receptacle axially aligned to face in opposition to the first receptacle, and
a support extending radially from a mid-region between the first receptacle and the second receptacle; and
an electrical contact held on the support having an electrical connection extended through the base to be exposed for electrical connection in at least one of the first receptacle and the second receptacle.

2. The base in claim 1, wherein the second receptacle is similar in size and shape to the first receptacle.

3. The base in claim 1, wherein the support includes a radially extending flange having a face.

4. The base in claim 1, wherein the support is centered between an axial end of the first receptacle and an axial end of the second receptacle.

5. The base in claim 4, wherein the electrical contact includes an axially aligned pin extending from the face of the flange.

6. The base in claim 1, wherein the first receptacle for a lamp capsule is defined by a wall forming a first end of a cavity that extends through the body and defines at a second end of the cavity, the second receptacle.

7. A reversible base for a lamp capsule comprising:
an insulating body having
a wall defining a first receptacle for a lamp capsule, and
defining a second receptacle for a lamp capsule, the second receptacle axially aligned to face in opposition to the first receptacle, being similar in size and shape to the first receptacle; and
a support being positioned between an axial end of the first receptacle and an axial end of the second receptacle and extending radially from a mid-region between the first receptacle and the second receptacle, the support including a radially extending flange having a face and a side wall; and
an electrical contact held on the support having an axially aligned coupling extending from the face of the flange and having an electrical connection extended through the base to be exposed for electrical connection in at least one of the first receptacle and the second receptacle.
